(19) United States
(12) Patent Application Publication
(10) Pub. No.: US 2026/0160407 A1
(43) Pub. Date: Jun. 11, 2026

(54) LIGHT TRACKING SYSTEM AND ASSOCIATED METHODS

(71) Applicant: Na’cho Production and Design, LLC, Kissimmee, FL (US)

(72) Inventor: Nathaniel Cromwell, Kissimmee, FL (US)

(73) Assignee: Na’cho Production and Design, LLC, Kissimmee, FL (US)

(21) Appl. No.: 19/411,800

(22) Filed: Dec. 8, 2025

Related U.S. Application Data
(60) Provisional application No. 63/729,800, filed on Dec. 9, 2024.

(51) Int. Cl. F21V 21/36; F21V 21/15; G01S 5/04

(52) U.S. Cl. CPC F21V 21/36; F21V 21/15; G01S 5/04

(57) ABSTRACT

A light tracking system may include a lighting unit configured to emit a lighting beam and to rotatably move about one or more axes to change a direction of the lighting beam. The system may also include a hoist and a lighting controller in communication with the lighting unit. The system may further include a tracking controller in communication with the hoist controller and the lighting controller. The tracking controller may be configured to receive tracking data regarding a location of a tracked object, and to generate a dynamic control signal based on the tracking data. The tracking controller may also be configured to send the dynamic control signal to both the lighting controller and the hoist controller to coordinate positioning of the lighting unit and the lighting mount to maintain the lighting beam on the tracked object.

### FIELD OF THE INVENTION

The present invention relates to systems and methods for tracking an object for dynamic lighting.

### BACKGROUND OF THE INVENTION

Dynamic lighting systems have become increasingly prevalent in entertainment venues, sports facilities, and performance spaces where the ability to automatically adjust illumination based on moving subjects enhances both safety and visual experience. Traditional lighting systems typically employ fixed positioning and manual control mechanisms, which limit their responsiveness to changing conditions and moving objects within the illuminated area.

Conventional lighting control approaches often rely on passive infrared sensors or simple motion detection systems that can only provide basic on-off functionality or rudimentary dimming capabilities. These systems frequently suffer from inability to distinguish between different types of objects, leading to unwanted activation by non-target subjects such as small animals or debris. Additionally, such systems typically cannot predict movement patterns or proactively adjust lighting coverage areas.

In performance and entertainment applications, the coordination of multiple lighting elements presents additional challenges. Traditional systems require extensive manual programming and real-time operator control to achieve synchronized lighting effects that follow performers or objects of interest. This manual approach is labor-intensive and may not provide the precision and responsiveness desired for dynamic tracking applications.

Recent developments in the field have explored various tracking methodologies, including acceleration-based systems and camera-based recognition technologies. Some approaches utilize wearable sensors that transmit position data to lighting control systems, while others employ computer vision techniques to identify and track subjects within a defined area. However, these systems often operate in isolation without integrated control of both lighting positioning and mounting hardware.

Various prior art systems have attempted to address aspects of automated lighting control. For example, WO-2021136193-A1 assigned to Ople Lighting Co Ltd, and Shuzhou Op Lighting Co Ltd., discloses an illumination apparatus with a direction-adjustable illumination device and an acceleration sensor used to track an object. The acceleration sensor is mounted on the tracked object and wirelessly connected to the illumination device. The system measures reference acceleration values, sampled acceleration values, and deflection angles during movement of the tracked object. The illumination device calculates the coordinates of the tracked object after movement and determines rotation angles for a lamp body module (including horizontal and vertical motors) to track the object. The system uses double integration of acceleration data to calculate displacement values for improved tracking accuracy.

As another example, U.S. Published Patent Application No. 2022025665-A1 by Cao et al. discloses a camera system for a venue that includes cameras mounted above the venue and a server with artificial intelligence (AI) adapted to follow a subject. The AI generates aiming instructions based on the position of a subject. The system includes wide area LED lights mounted to light poles, with the server adapted to vary light intensity based on the subject's position. The system may include special effects (smoke generators, fireworks, sound effects, video displays), user apps for control, payment systems, motion tracking cameras, and multiple priority levels for different users (facilities managers, coaches, players). The system enables automated lighting management and can be controlled through smartphone applications.

Despite these developments, existing systems may not adequately address the need for integrated control that coordinates both the directional adjustment of lighting units and the physical positioning of lighting mounts through automated hoist systems. Many prior art approaches focus on either tracking functionality or lighting control in isolation, without providing a unified system that dynamically adjusts both the orientation of individual lighting units and the vertical and horizontal positioning of the mounting structure carrying those units.

In performance and entertainment applications, the coordination of multiple lighting elements presents additional challenges. Traditional systems require extensive manual programming and real-time operator control to achieve synchronized lighting effects that follow performers or objects of interest. This manual approach is labor-intensive and may not provide the precision and responsiveness desired for dynamic tracking applications.

Accordingly, additional improvements in the field, especially as it is applied to entertainment applications, is necessary.

### SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

With the foregoing in mind, the present invention is directed to a light tracking system that includes a lighting unit configured to emit a lighting beam and to rotatably move about one or more axes to change a direction of the lighting beam. The system may also include a hoist controller configured to control movement of a lighting mount carrying the lighting unit. The system may further include a lighting controller in communication with the lighting unit and configured to generate a lighting command to control the lighting unit. The system may also include a tracking controller in communication with the hoist controller and the lighting controller. The tracking controller may be configured to receive tracking data regarding a location of a tracked object. The tracking controller may also be configured to generate a dynamic control signal based on the tracking data. The tracking controller may still further be configured to send the dynamic control signal to both the lighting controller and the hoist controller to coordinate positioning of the lighting unit and the lighting mount to maintain the lighting beam on the tracked object.

The light tracking system may also include a tracking unit configured to monitor the tracked object and generate the tracking data. The tracking unit may include a camera configured to capture images of the tracked object for image recognition and/or facial recognition. The tracking unit may also a distance finder sensor configured to detect a distance of the tracked object from the tracking unit.

The light tracking system may further include a location unit configured to be carried by the tracked object and to transmit location data to the tracking controller. The location unit may be configured to detect its location using signal triangulation with measurement signals received from multiple tracking units. The lighting unit may be configured to movably pan and movably tilt to change the direction of the lighting beam.

The light tracking system may also include a lighting hoist controlled by the hoist controller. The lighting hoist may be configured to move the lighting mount between a raised position and a lowered position.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 is a schematic diagram of a light tracking system according to an embodiment of the present invention.

FIGS. 2A-2C are perspective views of the light tracking system of FIG. 1, shown tracking an object to direct the lighting units and actuate the lighting mount.

FIG. 3 is a perspective view of a light tracking system according to an embodiment of the present invention, shown with a portion of a plurality of lighting units being directed towards a tracked object.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a light tracking system 100 to dynamically track objects 107 to direct lighting beams 114 from controlled lighting units 101 to maintain the lighting beams 114 on the tracked objects 107, such as, and without limitation, during when the tracked objects 107 are in motion and during when the tracked objects 107 are not in motion. Throughout this specification, the light tracking system 100 is also referred to as a lighting system 100 or a system 100. This interchangeability in nomenclature does not affect the scope of the application in any way.

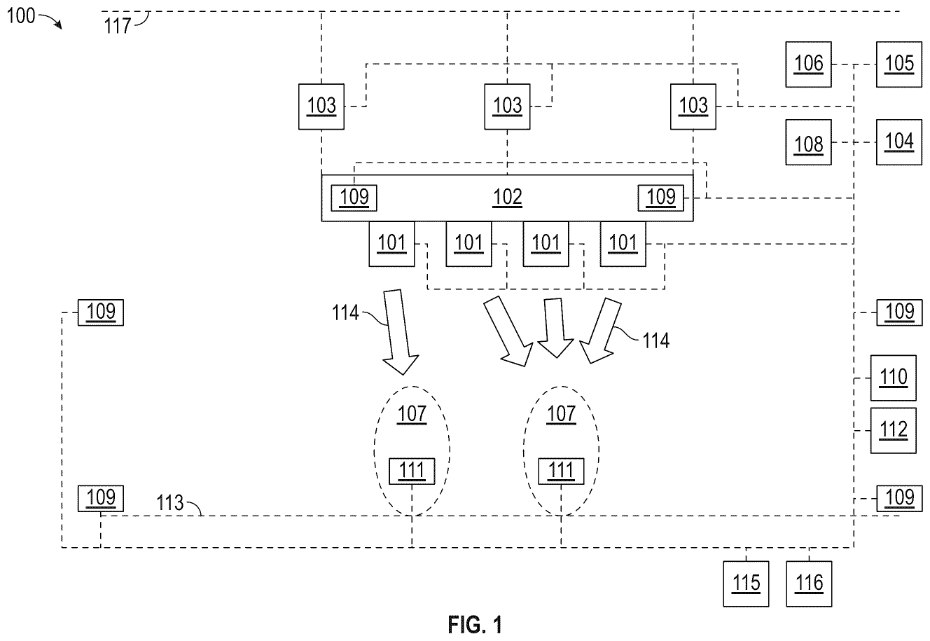

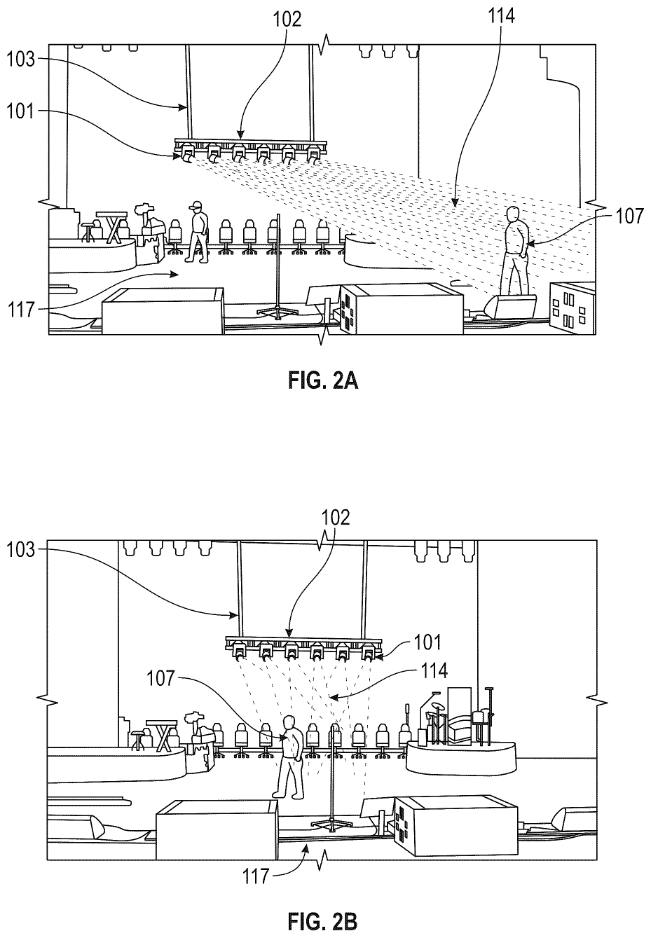

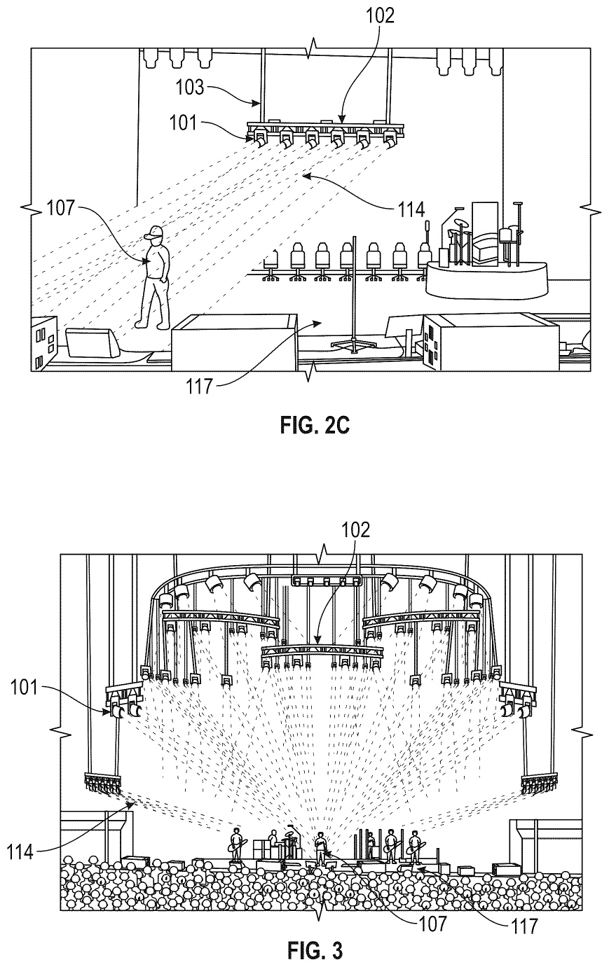

Now referring to FIGS. 1-3, and embodiment of the lighting system 100 may include one or more lighting units 101, a lighting controller 105, a tracking controller 104, one or more tracking units 109, and/or one or more location units 111. The lighting units 101 may be operable to emit a lighting beam 114, and the lighting units 101 may be configured to rotatably move about one or more axes traveling therethrough. For example, without limitation, each of the lighting units 101 may be configured to movably pan and/or moveably tilt, which may respectively cause a change in the direction of the light beam 114 emitted from the lighting unit 101. The lighting units 101 may be operable to be controlled by the lighting controller 105 and/or the tracking controller 104 to rotatably move the lighting unit(s) 101 and/or to movably pan and/or tilt the lighting unit(s) 101.

The tracking units 109 may be adapted to monitor, sense, detect, and track one or more objects 107, which may be referred to herein without limitation as a tracked object 107. The tracking units 109 may be mounted on and/or adjacent to a surface, such as a performance surface 113. The performance surface 113 may comprise an upper surface area where an object 107 to be tracked and/or a tracked object 107 may be located thereon and/or expected to be located thereon.

As further illustrated in FIG. 1, an interface 110 or a user interface 110, may be provided to allow a user to monitor and provide override control. More specifically, a user may desire to monitor the lighting units 101, the lighting hoist 103, the hoist controller 106, the lighting controller 105, the tracking unit 109, the power unit 112, or any other of the components of the light tracking system 100 according to the present invention. As such, the user interface 110 allows for such monitoring. In addition, the interface 110 allows for a user to take manual action to send a signal to the lighting controller to move the lighting unit 101 in a particular direction should an override, for example, be necessary.

The tracking units 109 may be adapted to monitor, sense, detect, and track the objects 107 by utilizing image recognition, facial recognition, relative distance detection, and/or triangulation. In some embodiments of the present invention, the tracking units 109 may capture one or more images and/or video recordings of at least a portion of a space adjacent to the surface 113 where an object 107 to be tracked and/or a tracked object 107 may be location therein/thereat. The tracking unit 109 may send the captured images and/or video recording as tracking data to the tracking controller 104. In such embodiments of the present invention, the tracking units 109 may comprise, without limitation, a camera and/or optical sensor.

The tracking controller 104 may be operable to perform image recognition on the tracking data to identify the object 107 captured therein and determine the location of the object 107. The tracking controller 104 may determine the location of the object 107 relative to the tracking unit(s) 109, relative to at least a portion of the surface 113, and/or relative to the location of the lighting unit(s) 101. The tracking controller 104 may also be operable to perform image recognition on the tracking data to determine a height of the tracked object 107, and/or to determine the orientation of the tracked object 107.

In some embodiments of the present invention, the tracking units 109 may be configured to detect the distance of the tracked object 107 from the tracking unit 109. The tracking units 109 may generate and send the detected distance of the tracked object 107 from the tracking unit 109 as tracking data to the tracking controller 104. The tracking controller 104 may be configured to determine the position of the object 107 based on the tracking data received. In some embodiments of the present invention the tracking controller 104 may receive tracking data from more than one tracking unit 109, and the tracking controller 104 may be configured to determine the position of the object 107 by using the multiple tracking data received thereby to triangulate the position of the object 107. The tracking units 109 may comprise, without limitation, a distance finder sensor.

Some embodiments of the present invention may include one or more location units 111. The location units 111 may be wearable by, carriable by, attachable to, and/or mountable on the object(s) 107 to be tracked and/or one the tracked object(s) 107. The location units 111 may be operable to detect the location of the location unit 111, which may be associated with the location of the object 107 to be tracked and/or of the tracked object 107, and which may be referred to herein as location data. The location units 111 may be adapted to send the location data to the tracking units 109 and/or to the tracking controller 104. The tracking units 109 may comprise a receiver to receive the location data from the location units 111, and the tracking units 109 may be adapted to relay the location data received to the tracking controller 104. The tracking controller 104 may be adapted to identify, monitor, and/or determine the location of the tracked object 107 based on the location data received thereby.

In some embodiments of the present invention, the location unit(s) 111 may be adapted to detect the location of the location of the location unit 111 by utilizing a global positioning system GPS). The location unit(s) 111 may be positioned and/or positionable in communication with one or more GPS satellites to monitor, identify, and/or determine the location of the location device 111 and/or of the object 107.

In some other embodiments of the present invention, the location devices 111 may be adapted to detect the location of the location of the location unit 111 by utilizing signal triangulation. Each tracking unit 109 may be adapted to perform as an anchor signal unit that may be in communication with and/or positionable in communication with one or more of the location device(s) 111. The tracking units 109 may be configured to emit measurement signals that may be received by the location unit(s) 111. The tracking units 109 may emit and/or transmit the measurement signals at predetermined points of time that are each uniformly separated by a predetermined period of time, which may be referred to herein without limitation as a uniform transmission frequency.

Each measurement signal of the measurement signals may be significantly the same as each other measurement signal of the measurement signals, such that the amplitudes, periods, wavelength, and/or frequencies of the measurement signals may be significantly the same. The location units 111 may be adapted to identify that point of time at which a measurement signal has been received by the location unit 111 transmitted from a tracking unit 109. The location unit 111 may determine the length of time between the point of time the measurement signal was received by the location unit 111 and the point of time the measurement signal was transmitted from the tracking unit 109 to define a transmission period associated with the measurement signal.

The location unit 111 may be adapted to determine the distance between the location unit 111 and the tracking unit 109 which transmitted the measurement signal based on the transmission periods associated with that measurement signal, which may be referred to as relative distance data. The location unit 111 may also be adapted to compare the relative distance data of measurement signals received by the location unit 111 from more than one tracking unit 109 which where transmitted at the same point of time to determine a two-dimensional and/or a three-dimensional location of the location unit 111, which may be referred to herein, without limitation, as location data.

The location unit 111 may send the location data to the tracking controller 104, and the tracking controller 104 may be adapted to identify, detect, determine, and/or monitor to the location of the location unit 111 based on the location data received to also to identify, detect, determine, and/or monitor the location of the object 107 and/or tracked object 107 associated with the location unit 111. In some embodiments of the present invention, such as, but without limitation, in the aforementioned embodiment, the tracking units 109 may comprise ultra-wideband (UWB) emitters, the measurement signals may comprise UWB signals, and the location units 111 may include UWB signal receivers. The tracking units 109 may each be positioned at different positions at and/or adjacent to a perimeter of the performance surface 113, such as, without limitation, at two or more corners, edges, ends, and/or portions of the perimeter of the performance surface 113.

In some embodiments of the present invention, the location units 111 may be adapted to detect the location of the location of the location unit 111 by triangulation utilizing proximity detection. The tracking units 109 may be adapted to emit and/or transmit measurement signals to be received by the location unit 111. The measurement signals may comprise distance affected signals that may lower in signal strength in relation to the total distance traveled by the distance affected signal between the location the tracking unit 109 transmitted the measurement signal and the location at which the measurement signal is received by the location unit 111.

Specifically, the measurement signals may lower in signal strength uniformly in proportion to the distance traveled by the measurement signal between the transmission and the receipt thereof, such that, a measurement signal that traveled a short distance (“distance A”) may have a signal strength that is greater than the signal strength of a measurement signal that traveled a greater distance (“distance B”) that is longer than distance A, and such that a measurement signal that traveled a distance that ends between that end points of distance A and distance B, would have a signal strength that is significantly equal to the signal strength of the following equation: (distance A+½(distance B−distance A)).

The location unit 111 may sense and/or detect the signal strength of each measurement signal received by the location unit 111. Each measurement signal 111 may also comprise a transmission time. The location unit 111 may be adapted to determine the distance between the location unit 111 and the tracking unit 109 that transmitted a measurement signal that has been received by the location unit 111 based on the signal strength of the measurement signal, which may be referred to herein, without limitation, as distance data. The location unit 111 may also be adapted to determine and/or triangulate the location of the location unit 111 by comparing the distance data of each measurement signal with the same transmission time which has been received by the location unit 111, which may define location data.

The location unit 111 may be operable to transmit the location data to the tracking units 109 and/or to the tracking controller 104. The tracking controller 104 may be operable to identify, determine, and/or monitor the location of the location unit 111 and/or the location of the tracked object 107 associated with the location unit 111 based on the location data received therefrom by the tracking controller 104.

In some embodiments of the present invention, the location units 111 may be positioned on an object 107 to be tracked and/or on a tracked object 107 such that at least one of the location units 111 may be visible and/or detectable by one or more of the tracking units 109. For example, without limitation, the location units 111 may comprise a material and/or device that may be visible and/or detectable by one or more of the tracking units 109 whether visibly unobstructed, partially visibly obstructed, and/or minorly visibly obstructed by foreign object(s), such as, clothing, accessories, costumes, and/or other items wearable by a person. Specifically, the location units 111 may be detectable and/or visible to the tracking units 109 via means other than means via visible light, such as, and without limitation, via radio-wave spectrum.

The location units 111 may comprise a radio-wavelength reflective material, and the location units 111 may be carried by the object 107 to be track and/or by the tracked object 107. The location units 111 may also each be positioned at predetermined positions on the object 107, and each location unit 111 may be associated with the predetermined position that the location unit 111 is positioned at on the object 107. The tracking units 109 may be configured to emit a measurement signal that may comprise one or more radio wavelengths and/or frequencies. The location units 111 may reflect the measurement signals to be received back by the tracking units 109.

The tracking units 109 may sense, detect, determine, and/or identify the amount of time between the measurement signals being transmitted by the tracking units 109 and received back by the tracking units 109 to determine a distance between each of the tracking units 109 and the location units 111, which may be referred to herein, without limitation, as distance data. The tracking units 109 may transmit the distance data to the tracking controller 104. The tracking controller 104 may be adapted to detect, identify, determine, and/or monitor the location of the location unit(s) 111 and the location of the tracked object 107 associated with the location unit(s) 111 based on the distance data received.

It should be understood throughout the description of the present invention herein, that embodiments of the present invention may include either a single tracking unit 109, a single location unit 111, multiple tracking units 109, and/or multiple location units 111, although they may be referred to herein in singular form and/or in plural form, while still accomplishing all the features, goals, and advantages of the embodiments of the present invention.

As described above, in embodiments of the present invention, the tracking controller 104 may identify, detect, determine, and/or monitor the location of the tracked object 107 based on tracking data, location data, and/or distance data received by the tracking controller 104 transmitted from the tracking unit(s) 109 and/or from the location unit(s) 111. The location of the tracked object identified, detected, determined, and/or monitored by the tracking controller 104 may be referred to herein, without limitation, as dynamic data. The tracking controller 104 may include and/or be in communication with at memory unit 115 and/or a data unit 116. The memory unit 115 and/or data unit 116 may be configured to store, index, read, write, and/or delete, computer-readable information, code, data, and/or executables. The data stored by the memory unit 115 and/or data unit 116 may be accessible by the tracking controller 104 and/or by the lighting controller 105.

The tracking controller 104, the memory unit 115, and/or the data unit 116 may store and/or provide past dynamic data and/or predetermined plan data. The tracking controller 104 may be configured to track and/or identify the current time of day, and/or the tracking controller 104 may be configured to track a current running time from a predetermined running start. The tracking controller 104 may be configured to generate a dynamic control signal. The tracking controller 104 may generate the dynamic control signal based on one or more of the dynamic data, the past dynamic data, the predetermined plan data, the current time of day, and/or the current running time. The tracking controller 104 may be configured to send the dynamic control signal to the lighting controller 105, to one or more of the lighting units 101, to an output module 108, to a hoist controller 106, and/or to one or more lighting hoists 103.

The lighting controller 105 may store past lighting data, predetermined plan data, and/or a copy of the predetermined plan data. The lighting controller 105 may be configured to track and/or identify the current time of day, and/or the lighting controller 105 may be configured to track the current running time from the predetermined running start. The lighting controller 105 may be in communication with the memory 115 and/or the data store 116, and the lighting controller 105 may be configured to access the data stored by the memory unit 115 and/or the data store 116.

The lighting controller 105 may be configured to generate a lighting command. The lighting controller 105 may generate the lighting command based on one or more of the dynamic control signal, the dynamic data, the past lighting data, the predetermined plan data, the current time of day, and/or the current running time. The lighting controller 105 may be configured to send the lighting command to the output module 108 and/or to one or more of the lighting units 101. The lighting units 101 may be responsive to the lighting command to take a predetermined lighting action. The predetermined lighting action may include, without limitation, one or more of, lower the luminosity of light emitted, increase the luminosity of light emitted, maintain the luminosity of light emitted, widen the beam width/angle of light emitted, narrow the beam width/angle of light emitted, change the color of light emitted, maintain the color of light emitted, stop emitting light, and/or begin emitting light.

In some embodiments of the present invention, the lighting controller 105 may be configured to control one or more of the lighting units 101 based on the lighting command to cause the one or more lighting units 101 to take one or more of the predetermined lighting actions described above. In some other embodiments of the present invention, the output module 108 may be configured to control one or more of the lighting units 101 based on the lighting command to cause the one or more lighting units 101 to take one or more of the predetermined lighting actions described above.

The tracking controller 104 may be configured to identify and/or generate a movement command based on the dynamic control signal. The tracking controller 104 may be configured to send the movement command to the output module 108. The tracking controller 104 and/or the output module 108 may be adapted to send the movement command and/or the dynamic control signal to one or more of the lighting units 101 to cause one or more of the lighting units 101 to take a predetermined movement action. The predetermined movement action taken by the one or more lighting units 101 may include, without limitation, one or more of the lighting units 101 rotatably move about one or more axes thereof, movably pan, movably tilt, and/or to maintain the orientation thereof, such that the lighting beam 114 generated and/or emitted by one or more of the lighting unit(s) 101 may be directed towards the tracked object 107.

The hoist controller 106 may be in communication with one or more lighting hoists 103. The lighting hoists 103 may be attached to a lighting mount 102 and attached to an upper inward portion 117 of a structure (not shown) that the performance surface 113 is located therein and/or that the performance surface 113 located adjacent to. As may be understood by those who may have skill in the art, the structure (not shown) may comprise any structure, building, venue, support structure, and/or scaffolding, without limitation. The attachment between the lighting hoists 103 and the lighting mount 102, and the attachment between the lighting hoists 103 and the upper inward portion 117 of the structure may comprise one or more of a rope, chain, cable, chord, line, and/or track and may be understood by those who may have skill in the art.

One or more of the lighting units 101 may be carried by and/or rotatably attached to the lighting mount 102. The light hoists 103 may be configured to move the lighting mount 102 between a raised position and a lowered position. The raised position may be defined as the distance between the lighting mount 102 and the upper inward surface 117 of the structure is shorter than the distance between the lighting mount 102 and the performance surface 113. The lowered position may be as the distance between the lighting mount 102 and the upper inward surface 117 of the structure is greater than the distance between the lighting mount 102 and the performance surface 113.

In some embodiments of the present invention, the lighting hoists 103 may be operable to be controlled by the hoist controller 106 to cause the lighting hoists 102 to move between the raised position and the lowered position. Although the figures illustratively showing the embodiments of present invention herein only depict a single lighting mount 102 that the lighting unit(s) 101 may be attached thereto, it should be understood that it is contemplated that some embodiments of the present invention may include multiple lighting mounts 102 that may each carry one or more lighting units 101, and that each lighting mount 102 may be attached to one or more lighting hoists 103, and that one or more of the lighting mounts 102 may not be attached to a lighting hoist 103 such that the lighting mount 102 may be in a fixed position and such that that lighting mount 102 may not be movable between the raised position and the lowered position.

The hoist controller 106 may store past hoist data, predetermined plan data, and/or a copy of the predetermined plan data. The hoist controller 106 may be configured to track and/or identify the current position of the lighting hoists 103, the current time of day, and/or hoist controller 106 may be configured to track the current running time from the predetermined running start. The hoist controller 106 may be in communication with the memory 115 and/or the data store 116, and the hoist controller 106 may be configured to access the data stored by the memory unit 115 and/or the data store 116.

The hoist controller 106 may be configured to generate a hoist command. The hoist controller 106 may generate the hoist command based on one or more of the dynamic control signal, the dynamic data, the past hoist data, the predetermined plan data, the current position of the lighting hoists 103, the current time of day, and/or the current running time. The hoist controller 106 may be configured to send the hoist command to one or more of the lighting hoists 103. The lighting hoists 103 may be responsive to the hoist command to take a predetermined hoist action. The predetermined hoist action may include, without limitation, one or more of, maintain the position of the lighting mount(s) 102, move the lighting mount(s) 102 to/towards the raised position, move the lighting mount(s) 102 to/towards the lowered position, maintain the position of one or more of the lighting mount(s) 102, move one or more of the lighting mount(s) 102 to/towards the raised position, and/or move one or more of the lighting mount(s) 102 to/towards the lowered position. In some embodiments of the present invention, the hoist controller 106 may be configured to control one or more of the lighting hoist(s) 103 based on the hoist command to cause the one or more of the lighting hoist(s) 103 to take one or more of the predetermined hoist actions described above.

Embodiments of the present invention may include one or more of a power unit 112. The power unit 112 may be in communication with one or more of the hoist controller 106, the lighting controller 105, the tracking controller 104, the output module 108, the lighting unit(s) 101, the lighting mount 102, the lighting hoist(s) 103, the tracking unit(s) 109, the location unit(s) 111, the memory unit(s) 115, and/or the data unit(s) 116. The power unit 112 may be configured to provide power to one or more of the aforementioned components. The power unit 112 may comprise one or more of a battery and/or a line connected to a power hookup/outlet, and/or any other power source that may be utilized as the power unit 112 as may be understood by those who may have skill in the art.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A light tracking system, comprising:
a lighting unit configured to emit a lighting beam and to rotatably move about one or more axes to change a direction of the lighting beam;
a hoist controller configured to control movement of a lighting mount carrying the lighting unit;
a lighting controller in communication with the lighting unit and configured to generate a lighting command to control the lighting unit; and
a tracking controller in communication with the hoist controller and the lighting controller;
wherein the tracking controller is configured to receive tracking data regarding a location of a tracked object;
wherein the tracking controller is configured to generate a dynamic control signal based on the tracking data; and
wherein the tracking controller is configured to send the dynamic control signal to both the lighting controller and the hoist controller to coordinate positioning of the lighting unit and the lighting mount to maintain the lighting beam on the tracked object.

2. The light tracking system of claim 1, further comprising a tracking unit configured to monitor the tracked object and generate the tracking data.

3. The light tracking system of claim 2, wherein the tracking unit comprises a camera configured to capture images of the tracked object for at least one of image recognition and facial recognition.

4. The light tracking system of claim 2, wherein the tracking unit comprises a distance finder sensor configured to detect a distance of the tracked object from the tracking unit.

5. The light tracking system of claim 1, further comprising a location unit configured to be carried by the tracked object and to transmit location data to the tracking controller.

6. The light tracking system of claim 5, wherein the location unit is configured to detect its location using signal triangulation with measurement signals received from multiple tracking units.

7. The light tracking system of claim 1, wherein the lighting unit is configured to movably pan and movably tilt to change the direction of the lighting beam.

8. The light tracking system of claim 1, further comprising a lighting hoist controlled by the hoist controller and configured to move the lighting mount between a raised position and a lowered position.

9. A light tracking system, comprising:
one or more lighting units configured to emit lighting beams and to rotatably move about one or more axes to change directions of the lighting beams;
a lighting mount carrying the one or more lighting units;
one or more lighting hoists attached to the lighting mount and configured to move the lighting mount between a raised position and a lowered position;
a hoist controller in communication with the one or more lighting hoists and configured to generate a hoist command to control movement of the lighting mount;
a lighting controller in communication with the one or more lighting units and configured to generate a lighting command to control the one or more lighting units;
one or more tracking units configured to monitor and detect a tracked object and generate tracking data; and
a tracking controller in communication with the one or more tracking units, the hoist controller, and the lighting controller;
wherein the tracking controller is configured to receive the tracking data, determine a location of the tracked object based on the tracking data, generate a dynamic control signal based on the determined location, and send the dynamic control signal to coordinate the lighting beams to be directed toward the tracked object.

10. The light tracking system of claim 9, wherein the one or more tracking units comprise a camera configured to capture images of the tracked object for at least one of image recognition and facial recognition.

11. The light tracking system of claim 9, wherein the one or more tracking units comprise a distance finder sensor configured to detect a distance of the tracked object from the tracking unit.

12. The light tracking system of claim 9, further comprising one or more location units configured to be carried by the tracked object and to transmit location data to the tracking controller.

13. The light tracking system of claim 12, wherein the one or more location units are configured to detect their location using signal triangulation with measurement signals received from the one or more tracking units.

14. The light tracking system of claim 13, wherein the one or more tracking units comprise ultra-wideband emitters, the measurement signals comprise ultra-wideband signals, and the one or more location units comprise ultra-wideband signal receivers.

15. The light tracking system of claim 9, wherein the one or more lighting units are configured to movably pan and movably tilt to change the directions of the lighting beams in response to the lighting command from the lighting controller.

16. A method for tracking an object with a light tracking system, comprising the steps of:
emitting a lighting beam from a lighting unit configured to rotatably move about one or more axes;
receiving tracking data regarding a location of a tracked object at a tracking controller;
generating a dynamic control signal at the tracking controller based on the tracking data;
sending the dynamic control signal from the tracking controller to a lighting controller in communication with the lighting unit;
sending the dynamic control signal from the tracking controller to a hoist controller configured to control movement of a lighting mount carrying the lighting unit;
generating a lighting command at the lighting controller based on the dynamic control signal;
generating a hoist command at the hoist controller based on the dynamic control signal; and
coordinating positioning of the lighting unit and the lighting mount based on the lighting command and the hoist command to maintain the lighting beam on the tracked object.

17. The method of claim 16, further comprising capturing images of the tracked object using a camera for at least one of image recognition and facial recognition to generate the tracking data.

18. The method of claim 16, further comprising detecting a distance of the tracked object from a tracking unit using a distance finder sensor to generate at least a portion of the tracking data.

19. The method of claim 16, further comprising receiving location data from a location unit carried by the tracked object at the tracking controller.

20. The method of claim 19, wherein the location unit detects its location using signal triangulation with measurement signals received from multiple tracking units.
